(19) United States
(12) Patent Application Publication
(10) Pub. No.: US 2021/0216458 A1
(43) Pub. Date: Jul. 15, 2021

(54) MEMORY SYSTEM PERFORMING HOST MAP MANAGEMENT

(71) Applicant: SK hynix Inc., Icheon (KR)

(72) Inventor: Hye Mi KANG, Icheon (KR)

(21) Appl. No.: 16/901,888

(22) Filed: Jun. 15, 2020

(30) Foreign Application Priority Data
Jan. 15, 2020 (KR) 10-2020-0005357

(51) Int. Cl. G06F 12/0815; G06F 9/4401

(52) U.S. Cl. CPC G06F 12/0815; G06F 2212/608; G06F 9/4418

(57) ABSTRACT

A memory system includes a storage medium configured to store map data and a controller configured to perform a host map cache management operation so that the map data is stored in a host map cache included in a host device in response to the activation of a host map cache management function and configured to selectively deactivate the host map cache management function.

### CROSS-REFERENCES TO RELATED APPLICATION

The present application claims priority under 35 U.S.C. § 119(a) to Korean Patent Application Number 10-2020-0005357, filed on Jan. 15, 2020, in the Korean Intellectual Property Office, which is incorporated herein by reference in its entirety as set forth in full.

### BACKGROUND

### 1. Technical Field

Various embodiments generally relate to a memory system, and more particularly, to a memory system including a nonvolatile memory device.

### 2. Related Art

A memory system may be configured to store, in response to a write request from a host device, data provided from the host device. Also, the memory system may be configured to provide, in response to a read request from the host device, data stored therein to the host device. The host device may be an electronic device capable of processing data, and may include any of a computer, a digital camera, a mobile phone, and so forth. The memory system may be provided within the host device or may be manufactured as a component attachable to and detachable from the host device. The memory system may operate when it is coupled to the host device.

### SUMMARY

Various embodiments of the present disclosure provide a memory system capable of preventing degradation of operation performance thereof by selectively deactivating a host map cache management function, and an operating method thereof.

In accordance with an embodiment of the present disclosure, a memory system may include a storage medium and a controller. The storage medium may store map data. The controller may perform a host map cache management operation so that the map data is stored in a host map cache included in a host device in response to the activation of a host map cache management function, and may selectively deactivate the host map cache management function.

In accordance with an embodiment of the present disclosure, a memory system may include a storage medium and a controller. The storage medium may store map data. The controller may manage a number of transmissions of the map data to a host device in response to the activation of a host map cache management function, and may deactivate the host map cache management function based on the number of transmissions.

In accordance with an embodiment of the present disclosure, a memory system may include a storage medium and a controller. The storage medium may store map data. The controller may include a map cache configured to store the map data, and may activate or deactivate a host map cache management function for a host map cache that is capable of storing the map data separately from the map cache. The controller may determine whether there occurs an activation condition of the host map cache management function when there occurs a map cache miss within the map cache in response to a read request provided by a host device.

### BRIEF DESCRIPTION OF THE DRAWINGS

Features, aspects and embodiments are described in conjunction with the attached drawings, in which:

FIG. 1 is a block diagram illustrating a data processing system in accordance with an embodiment;

FIG. 2 is a state diagram illustrating state transition of a host map management function in accordance with an embodiment;

FIGS. 3A and 3B are a flowchart illustrating an operating method of the memory system of FIG. 1 in accordance with an embodiment;

FIG. 4 is a flowchart illustrating a method of a controller for performing a host map cache management operation when a host map cache management function is activated in accordance with an embodiment;

FIG. 5 illustrates a data processing system including a solid state drive (SSD) in accordance with an embodiment;

FIG. 6 illustrates a data processing system including a memory system in accordance with an embodiment;

FIG. 7 illustrates a data processing system including a memory system in accordance with an embodiment;

FIG. 8 illustrates a network system including a memory system in accordance with an embodiment; and

FIG. 9 illustrates a nonvolatile memory device included in a memory system in accordance with an embodiment.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The drawings are not necessarily to scale and, in some instances, proportions may have been exaggerated in order to clearly illustrate features of the embodiments. The terminology used herein is for the purpose of describing particular embodiments only and is not intended to be limiting of the invention.

As used herein, the term “and/or” includes at least one of the associated listed items. It will be understood that when an element is referred to as being “connected to”, or “coupled to” another element, it may be directly on, connected to, or coupled to the other element, or one or more intervening elements may be present. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements.

Hereinafter, exemplary embodiments of the present disclosure will be described below with reference to the accompanying drawings.

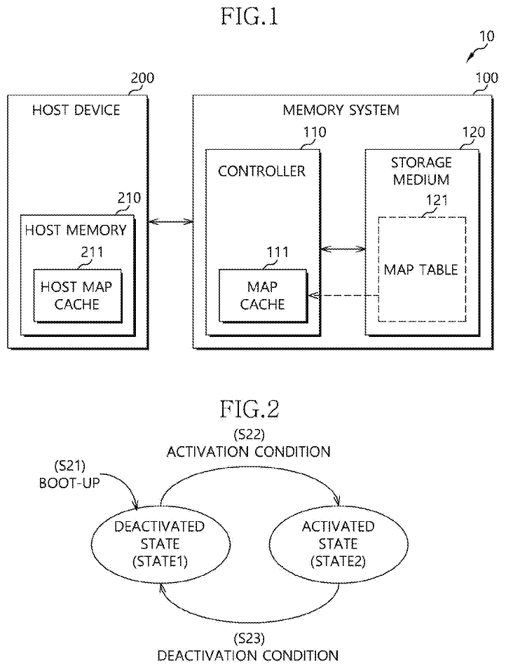

FIG. 1 is a block diagram illustrating a data processing system 10 in accordance with an embodiment.

The data processing system 10 may be an electronic system capable of processing data. The data processing system 10 may include a memory system 100 and a host device 200.

The host device 200 may include any of a personal computer, a laptop computer, a smartphone, a tablet computer, a digital camera, a game console, a navigation device, a virtual reality device, a wearable device, and so forth.

The memory system 100 may be configured to store, in response to a write request from the host device 200, data provided by the host device 200. Also, the memory system 100 may be configured to provide, in response to a read request from the host device 200, data stored therein to the host device 200.

The memory system 100 may be configured by a Personal Computer Memory Card International Association (PCMCIA) card, a Compact Flash (CF) card, a smart media card, a memory stick, any of various multimedia cards (MMC, eMMC, RS-MMC, and MMC-Micro), any of various secure digital cards (SD, Mini-SD, and Micro-SD), a Universal Flash Storage (UFS), a Solid State Drive (SSD), or the like.

The memory system 100 may include a controller 110 and a storage medium 120.

The controller 110 may control a general operation of the memory system 100. The controller 110 may control the storage medium 120 in order to perform a foreground operation in response to a request from the host device 200. The foreground operation may include an operation of writing data in the storage medium 120 and an operation of reading data from the storage medium 120 in response to requests (e.g., a write request and a read request) from the host device 200.

The controller 110 may control the storage medium 120 in order to perform a background operation that is internally necessary and independent of the host device 200. The background operation may include a wear leveling operation, a garbage collection operation, an erase operation, a read reclaim operation, a refresh operation, and so forth that is performed on the storage medium 120. Like the foreground operation, the background operation may include an operation of writing data in the storage medium 120 and reading data from the storage medium 120.

The controller 110 may manage a map table 121 including map data, in which a logical address from the host device 200 is mapped to a physical address of the storage medium 120. A logical address may be an address used for the host device 200 to access the storage medium 120. A logical address may be an address the host device 200 assigns to data to be stored in the storage medium 120. A physical address mapped to the logical address may be an address indicating a memory region of the storage medium 120 in which the data is actually stored. When storing the data into the storage medium 120, the controller 110 may map the logical address of the data to the physical address indicating the memory region.

The controller 110 may manage, as map data, the logical address and the physical address that are mapped to each other. After that, when receiving a read request regarding the logical address from the host device 200, the controller 110 may identify the physical address mapped to the logical address from the map data, read data stored in the memory region corresponding to the identified physical address, and provide the read data to the host device 200.

The map table 121 may include map data of all logical addresses that the host device 200 uses. Therefore, a size of the map table 121 is enormous, and thus the controller 110 may store the map table 121 in the storage medium 120.

The controller 110 may include a map cache 111. The map cache 111 may include a memory having rapid operation performance. In an embodiment, the map cache 111 may include a static random access memory (SRAM), but embodiments are not limited thereto.

The controller 110 may store map data, which is selected from the map table 121 in the storage medium 120, into the map cache 111. When receiving a read request from the host device 200, the controller 110 may refer to the map cache 111, which the controller 110 can access more rapidly, before referring to the map table 121 in the storage medium 120.

The controller 110 may process the read request by referring to the map data stored in the map cache 111 when map data corresponding to the read request is stored in the map cache 111, i.e., in a case of a cache hit. However, when the map data corresponding to the read request is not stored in the map cache 111, i.e., in a case of a cache miss, the controller 110 may load the map data corresponding to the read request from the storage medium 120 into the map cache 111, and may refer to the map data loaded into the map cache 111.

Here, since a capacity of the map cache 111 is limited, map data, which is selected from the map cache 111 according to a predetermined replacement condition, may be evicted from the map cache 111. For example, when there occurs a cache miss and the map cache 111 is full of map data, map data least recently stored in the map cache 111, i.e., the oldest map data from among the map data stored in the map cache 111, may be evicted from the map cache 111 in order to load the map data corresponding to the read request into the map cache 111. However, in accordance with an embodiment, the predetermined replacement condition for selecting map data to be evicted from the map cache 111 will not be limited thereto but various replacement conditions may be applied instead.

In order to cache more map data thereby increasing read performance, the controller 110 may use, as a host map cache 211, at least a part of a host memory 210 included in the host device 200 by performing a host map cache management operation.

In detail, the controller 110 may determine whether there is map data satisfying a host map cache condition. The map data satisfying the host map cache condition may be stored in the host map cache 211. In an embodiment, the map data satisfying the host map cache condition may be map data having a reference number that is greater than a threshold value, the reference number representing the number of times that the map data is referred to in response to a read request. In another embodiment, the map data satisfying the host map cache condition may be map data that is most recently referred to. In still another embodiment, the map data satisfying the host map cache condition may be map data corresponding to logical addresses within a predetermined range that is determined by the host device 200.

When there is the map data satisfying the host map cache condition, the controller 110 may provide a map data hint to the host device 200. The map data hint may include information indicating the map data satisfying the host map cache condition (e.g., a logical address of the map data). The host device 200 may provide, based on the map data hint, the controller 110 with a map data request for the map data to be stored in the host map cache 211 (e.g., the map data satisfying the host map cache condition). The controller 110 may provide the map data to the host device 200 in response to the map data request. The host device 200 may store the map data received from the controller 110 into the host map cache 211.

The host device 200 may provide the controller 110 with a read request by referring to the map data stored in the host map cache 211. In detail, when map data corresponding to the read request is in the host map cache 211, i.e., in a case of a host map cache hit, the host device 200 may provide the controller 110 with the read request including the map data stored in the host map cache 211. The host device 200 may mark the read request with indication that the host map cache hit occurs. In this case, the controller 110 may process the read request by referring to the map data included in the read request. That is, the controller 110 may rapidly process the read request without referring to the map cache 111.

On the other hand, when the map data corresponding to the read request is not in the host map cache 211, i.e., in a case of a host map cache miss, the host device 200 may provide the controller 110 with a read request not including the map data. In this case, the controller 110 may process the read request by referring to the map data stored in the map cache 111 and/or the storage medium 120, as described above.

The storage medium 120 may store therein data transferred from the controller 110 under the control of the controller 110. The storage medium 120 may read data therefrom and provide the read data to the controller 110 under the control of the controller 110.

The storage medium 120 may include one or more nonvolatile memory devices. The nonvolatile memory devices may include a flash memory, such as a NAND flash memory or a NOR flash memory, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

The nonvolatile memory device may include one or more planes, one or more memory chips, one or more memory dies, or one or more memory packages.

The operation performance of the memory system 100 may be degraded due to transmission of map data from the controller 110 to the host map cache 211. In accordance with an embodiment of the present disclosure, the controller 110 may selectively deactivate the host map cache management function in order to prevent degradation of the operation performance of the memory system 100. The controller 110 may perform the host map cache management operation when the host map cache management function is activated. The controller 110 may not perform the host map cache management operation when the host map cache management function is deactivated. That is, the activation of the host map cache management function may be a condition for performing the host map cache management operation.

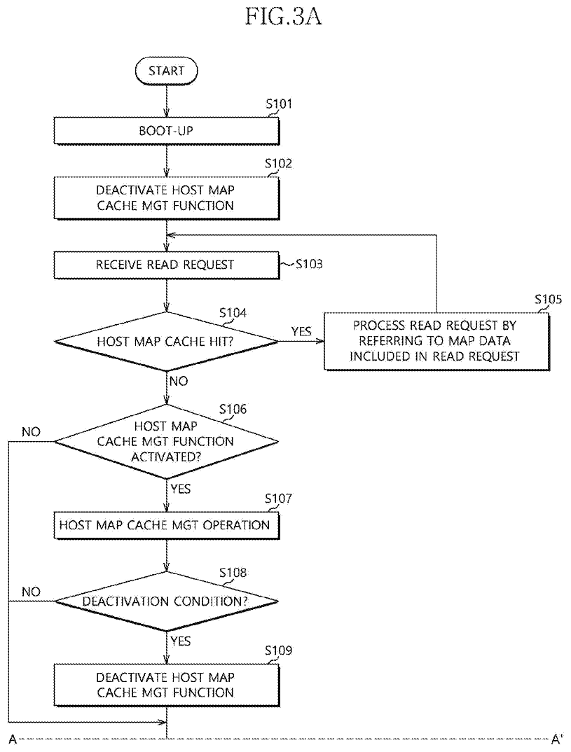

FIG. 2 is a state diagram illustrating state transition of the host map management function in accordance with an embodiment.

Referring to FIG. 2, the host map cache management function may be in a deactivated state STATE1 or an activated state STATE2.

In step S21, the host map cache management function may be deactivated when the memory system 100 is booted up. In an embodiment, the controller 110 may deactivate the host map cache management function when the memory system 100 is booted up. That is, when the memory system 100 is booted up, the map cache 111 may be completely empty and thus may have enough space to cache map data even though the host map cache 211 is not utilized. Therefore, the host map cache management function may be deactivated when the memory system 100 is booted up.

In step S22, when there occurs an activation condition while the host map cache management function is in the deactivated state STATE1, the controller 110 may activate the host map cache management function. In an embodiment, the activation condition may occur when there occurs replacement of map data stored in the map cache 111. The replacement of the map data stored in the map cache 111 may mean the shortage of an empty space in the map cache 111. Therefore, the host map cache management function may be activated when the replacement of the map data occurs.

In another embodiment, the activation condition may occur when the controller 110 receives a map data request from the host device 200 for a predetermined reason. The host device 200 may provide the map data request to the controller 110 in order to store map data into the host map cache 211, thereby increasing read performance of the memory system 100. In this case, the controller 110 may activate the host map cache management function regardless of whether the replacement of the map data occurs.

In step S23, when there occurs a deactivation condition while the host map cache management function is in the activated state STATE2, the controller 110 may deactivate the host map cache management function. In an embodiment, the deactivation condition may occur when the map cache 111 becomes to have an empty space to store map data. For example, the controller 110 may deactivate the host map cache management function when the map cache 111 becomes to have an empty space as the memory system 100 goes into a sleep mode or a map cache clear operation is performed on the map cache 111. That is, the controller 110 may deactivate the host map cache management function when the map cache 111 can sufficiently cache map data even without utilizing the host map cache 211.

In another embodiment, the deactivation condition may occur when the number of transmissions of map data to the host device 200 (hereinafter, referred to as the number of map data transmissions) becomes greater than a threshold value.

In still another embodiment, the deactivation condition may occur when a predetermined period of time elapses after the host map cache management function is activated.

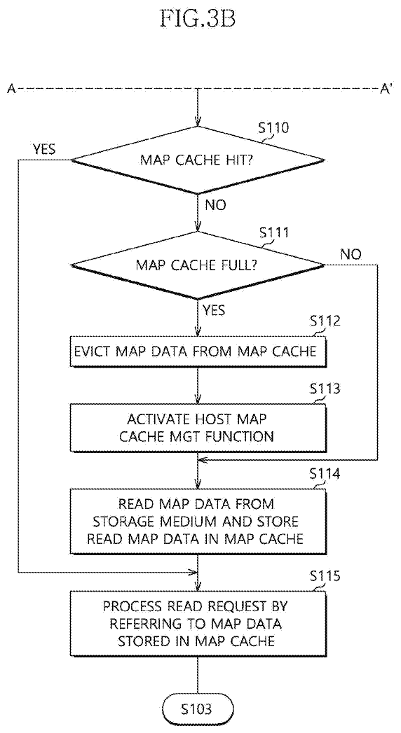

FIGS. 3A and 3B are a flowchart illustrating an operating method of the memory system 100 of FIG. 1 in accordance with an embodiment.

Referring to FIG. 3A, in step S101, the memory system 100 may be booted up.

In step S102, the controller 110 may deactivate the host map cache management function. In an embodiment, when the memory system 100 is booted up, the host map cache management function may be in an initial state that is a deactivated state.

In step S103, the controller 110 may receive a read request from the host device 200.

In step S104, the controller 110 may determine whether there occurs a host map cache hit. When the host map cache hit does not occur, i.e., when there occurs a host map cache miss, the process may go to step S106. When there occurs the host map cache hit, the process may go to step S105.

In step S105, the controller 110 may process the read request by referring to map data included in the read request. That is, by referring to the map data included in the read request, the controller 110 may read data from the storage medium 120 and may provide the read data to the host device 200. After that, the process may go back to step S103 to thereby receive a subsequent read request.

In step S106, the controller 110 may determine whether the host map cache management function is activated. When the host map cache management function is deactivated, the process may go to step S110 shown in FIG. 3B. When the host map cache management function is activated, the process may go to step S107.

In step S107, the controller 110 may perform the host map cache management operation.

In step S108, the controller 110 may determine whether the deactivation condition occurs. In an embodiment, the deactivation condition may occur when the map cache 111 becomes to have an empty space to store map data. In another embodiment, the deactivation condition may occur when the number of map data transmissions to the host map cache 211 becomes greater than a threshold value. In still another embodiment, the deactivation condition may occur when a predetermined period of time elapses after the host map cache management function is activated. When the deactivation condition does not occur, the process may go to step S110 shown in FIG. 3B. When the deactivation condition occurs, the process may go to step S109.

In step S109, the controller 110 may deactivate the host map cache management function.

Referring to FIG. 3B, in step S110, the controller 110 may determine whether there occurs a map cache hit. When there occurs the map cache hit, the process may go to step S115. When there occurs a map cache miss, the process may go to step S111.

In step S111, the controller 110 may determine whether the map cache 111 is full of map data. When the map cache 111 is not full of map data, the process may go to step S114. When the map cache 111 is full of map data, the process may go to step S112.

In step S112, the controller 110 may evict, from the map cache 111, map data selected according to the replacement condition.

As the replacement of map data occurs in step S112, in step S113, the controller 110 may activate the host map cache management function. That is, as there occurs the activation condition of the host map cache management function in step S112, i.e., as the replacement of map data occurs in the map cache 111, the host map cache management function may be activated. If the host map cache management function is in an activated state before step S113, the controller 110 may keep the host map cache management function activated.

In step S114, the controller 110 may read the map data, which corresponds to the read request, from the storage medium 120 and store the read map data into the map cache 111.

In step S115, the controller 110 may process the read request by referring to the map data stored in the map cache 111. That is, the controller 110 may read data from the storage medium 120 by referring to the map data stored in the map cache 111 and provide the read data to the host device 200. After that, the process may go back to step S103 so that the controller 110 receives a subsequent read request from the host device 200.

In an embodiment, the steps illustrated in FIG. 3 may be performed according to a sequence that is different from the sequence illustrated in FIG. 3. For example, although FIG. 3 shows that step S108 is performed after step S107, step S108 may be performed independently from step S107 in an embodiment. For example, the controller 110 may determine whether there occurs the deactivation condition for the host map cache management function in real time during an operation thereof or periodically.

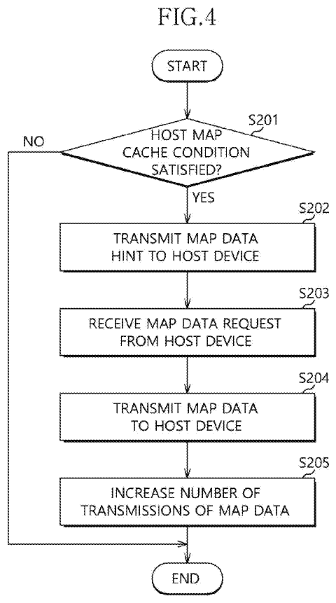

FIG. 4 is a flowchart illustrating a method of performing a host map cache management operation in accordance with an embodiment. The method illustrated in FIG. 4 may be an embodiment of step S107 of FIG. 3.

Referring to FIG. 4, in step S201, the controller 110 may determine whether there is map data satisfying the host map cache condition. In an embodiment, the map data satisfying the host map cache condition may be map data having a reference number that is greater than a threshold value, the reference number representing the number of times that the map data is referred to in response to a read request. In another embodiment, the map data satisfying the host map cache condition may be map data, that is most recently referred to. In still another embodiment, the map data satisfying the host map cache condition may be map data corresponding to logical addresses within a predetermined range that is determined by the host device 200. When there is no map data satisfying the host map cache condition, the process may end. When there is the map data satisfying the host map cache condition, the process may go to step S202.

In step S202, the controller 110 may provide a map data hint to the host device 200. The map data hint may include information indicating the map data satisfying the host map cache condition. The host device 200 may provide, based on the map data hint, the controller 110 with a map data request for map data to be stored in the host map cache 211.

In step S203, the controller 110 may receive the map data request from the host device 200.

In step S204, the controller 110 may provide the host device 200 with the map data corresponding to the map data request received from the host device 200. The map data corresponding to the map data request may include the map data satisfying the host map cache condition. The host device 200 may cache, into the host map cache 211, the map data received from the controller 110.

In step S205, the controller 110 may increase the number of map data transmissions.

In an embodiment, step S205 may be performed, so that the controller 110 determines whether the number of map data transmissions is greater than a threshold value, thereby determining if the deactivation condition of the host map cache management function occurs. In an embodiment, step S205 may be omitted.

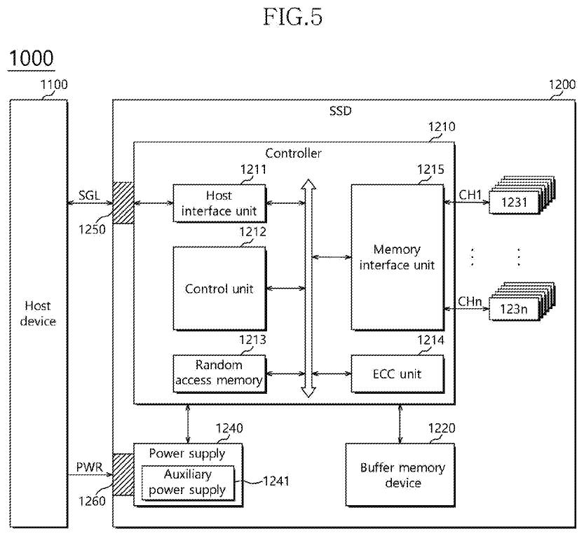

FIG. 5 is a diagram illustrating a data processing system 1000 including a solid state drive (SSD) 1200 in accordance with an embodiment. Referring to FIG. 5, the data processing system 1000 may include a host device 1100 and the SSD 1200.

The SSD 1200 may include a controller 1210, a buffer memory device 1220, a plurality of nonvolatile memory devices (NVMs) 1231 to 123n, a power supply 1240, a signal connector 1250, and a power connector 1260.

The controller 1210 may control general operations of the SSD 1200. The controller 1210 may be configured in the same manner as the controller 110 shown in FIG. 1.

The controller 1210 may include a host interface unit 1211, a control unit 1212, a memory 1213, an error correction code (ECC) unit 1214, and a memory interface unit 1215.

The host interface unit 1211 may exchange a signal SGL with the host device 1100 through the signal connector 1250. The signal SGL may include one or more of a command, an address, data, and so forth. The host interface unit 1211 may interface the host device 1100 and the SSD 1200 according to an interface protocol of the host device 1100. For example, the host interface unit 1211 may communicate with the host device 1100 according to any one of standard interface protocols such as secure digital (SD), universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E), universal flash storage (UFS), and so on.

The control unit 1212 may analyze and process the signal SGL received from the host device 1100. The control unit 1212 may control operations of internal function blocks according to a firmware or a software for driving the SSD 1200. The memory 1213 may be used as a working memory for driving such a firmware or software. The memory 1213 may include a random access memory.

The ECC unit 1214 may generate parity data of write data to be transmitted to at least one of the nonvolatile memory devices 1231 to 123n. The generated parity data may be stored together with the write data in the nonvolatile memory devices 1231 to 123n. The ECC unit 1214 may detect an error in data read from at least one of the nonvolatile memory devices 1231 to 123n based on parity data corresponding to the read data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide data stored in the buffer memory device 1220 to at least one of the nonvolatile memory devices 1231 to 123n, or provide data read from at least one of the nonvolatile memory devices 1231 to 123n to the buffer memory device 1220.

The buffer memory device 1220 may temporarily store data to be stored in at least one of the nonvolatile memory devices 1231 to 123n. Further, the buffer memory device 1220 may temporarily store data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260 to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include capacitors having large capacity.

The signal connector 1250 may be configured by various types of connectors depending on an interface scheme between the host device 1100 and the SSD 1200.

The power connector 1260 may be configured by various types of connectors depending on a power supply scheme of the host device 1100.

In FIG. 5, the host device 1100 may include a host map cache corresponding to the host map cache 211 shown in FIG. 1. The controller 1210 may perform the host map cache management operation described above with reference to FIGS. 1 to 4.

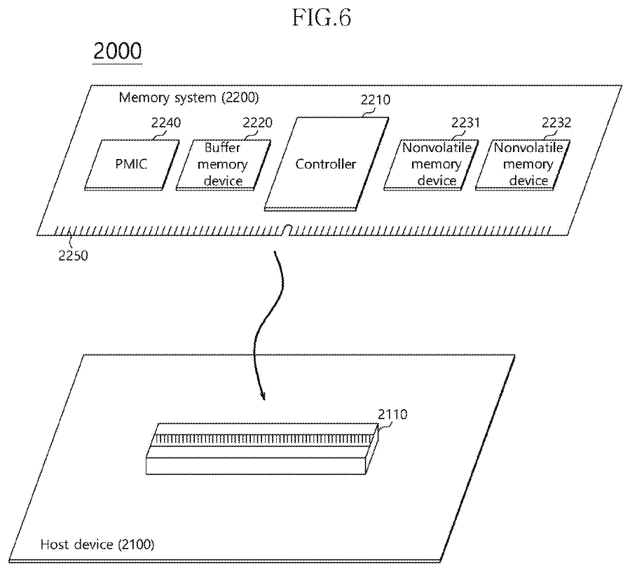

FIG. 6 is a diagram illustrating a data processing system 2000 including a memory system 2200 in accordance with an embodiment. Referring to FIG. 6, the data processing system 2000 may include a host device 2100 and the memory system 2200. The host device 2100 and the memory system 2200 shown in FIG. 6 may respectively correspond to the host device 200 and the memory system 100 shown in FIG. 1.

The host device 2100 may be configured in the form of a board such as a printed circuit board (PCB). Although not shown in FIG. 6, the host device 2100 may include internal function blocks for performing functions of the host device 2100.

The host device 2100 may include a connection terminal 2110 such as a socket, a slot, or a connector. The memory system 2200 may be mounted into the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices (NVMs) 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 5.

The buffer memory device 2220 may temporarily store data to be stored in the nonvolatile memory devices 2231 and 2232. Further, the buffer memory device 2220 may temporarily store data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250 to the inside of the memory system 2200. The PMIC 2240 may manage the power of the memory system 2200 according to control of the controller 2210.

The connection terminal 2250 may be coupled to the connection terminal 2110 of the host device 2100. Through the connection terminals 2110 and 2250, signals such as commands, addresses, data, and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

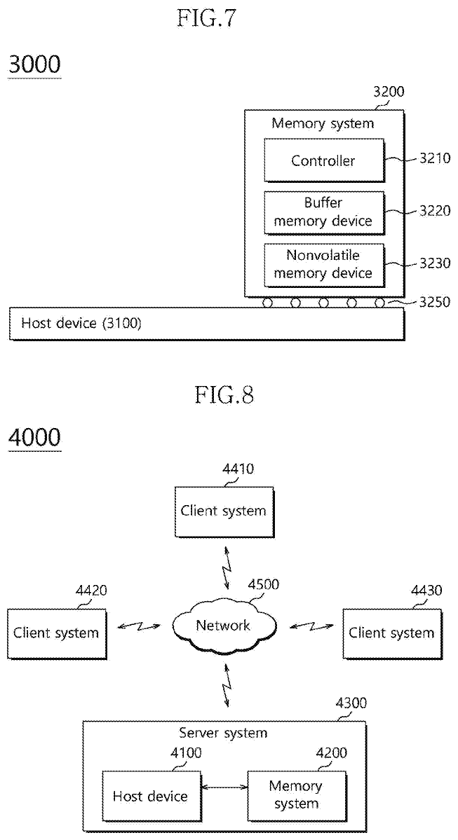

FIG. 7 is a diagram illustrating a data processing system 3000 including a memory system 3200 in accordance with an embodiment. Referring to FIG. 7, the data processing system 3000 may include a host device 3100 and the memory system 3200. The host device 3100 and the memory system 3200 shown in FIG. 7 may respectively correspond to the host device 200 and the memory system 100 shown in FIG. 1.

The host device 3100 may be configured in the form of a board such as a printed circuit board. Although not shown in FIG. 7, the host device 3100 may include internal function blocks for performing functions of the host device 3100.

The memory system 3200 may be configured in the form of a surface-mounting type package. The memory system 3200 may be mounted onto the host device 3100 through solder balls 3250. The memory system 3200 may include a controller 3210, a buffer memory device 3220, and a nonvolatile memory device (NVM) 3230.

The controller 3210 may control general operations of the memory system 3200. The controller 3210 may be configured in the same manner as the controller 1210 shown in FIG. 5.

The buffer memory device 3220 may temporarily store data to be stored in the nonvolatile memory device 3230. Further, the buffer memory device 3220 may temporarily store data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as a storage medium of the memory system 3200.

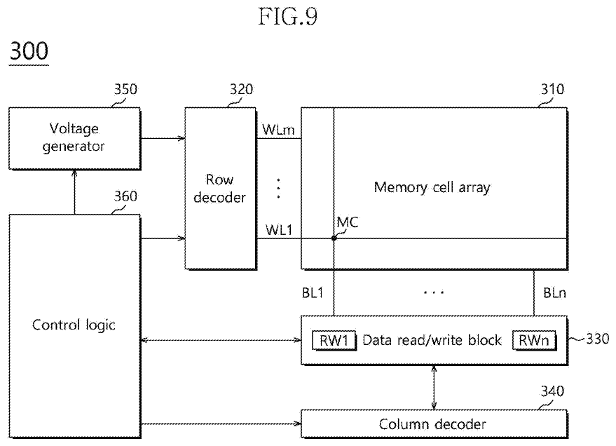

FIG. 8 is a diagram illustrating a network system 4000 including a memory system 4200 in accordance with an embodiment. Referring to FIG. 8, the network system 4000 may include a server system 4300 and a plurality of client systems 4410 to 4430 which are coupled to each other through a network 4500.

The server system 4300 may serve data in response to requests from the plurality of client systems 4410 to 4430. For example, the server system 4300 may store data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 5, the memory system 2200 shown in FIG. 6, or the memory system 3200 shown in FIG. 7.

FIG. 9 is a block diagram illustrating a nonvolatile memory device 300 included in a memory system in accordance with an embodiment. Referring to FIG. 9, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged in regions where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm based on a decoding result. For instance, the row decoder 320 may provide a word line voltage provided from the voltage generator 350 to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as the write driver which stores data provided from the external device in the memory cell array 310 in a write operation. For another example, the data read/write block 330 may operate as the sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, in a program operation, a program voltage may be applied to a word line of memory cells for which the program operation is to be performed. For another example, in an erase operation, an erase voltage may be applied to a well region of memory cells for which the erase operation is to be performed. For still another example, in a read operation, a read voltage may be applied to a word line of memory cells for which the read operation is to be performed.

The control logic 360 may control general operations of the nonvolatile memory device 300 based on control signals provided from the external device. For example, the control logic 360 may control operations of the nonvolatile memory device 300, such as read, write, and erase operations of the nonvolatile memory device 300.

While certain embodiments have been described above, it will be understood to those skilled in the art that the embodiments described are by way of example only. Accordingly, the memory system should not be limited based on the described embodiments. Rather, the memory system described herein should only be limited in light of the claims that follow when taken in conjunction with the above description and accompanying drawings.

What is claimed is:

1. A memory system comprising:
a storage medium configured to store map data; and
a controller configured to perform a host map cache management operation so that the map data is stored in a host map cache included in a host device in response to the activation of a host map cache management function and configured to selectively deactivate the host map cache management function.

2. The memory system of claim 1, wherein the controller includes a map cache configured to store the map data, and deactivates the host map cache management function when an empty space is generated within the map cache.

3. The memory system of claim 2, wherein the controller deactivates the host map cache management function when the empty space is generated within the map cache as the memory system goes into a sleep mode.

4. The memory system of claim 2, wherein the controller deactivates the host map cache management function when the empty space is generated within the map cache as a map cache clear operation is performed on the map cache.

5. The memory system of claim 1, wherein the controller manages a number of transmissions of map data to the host map cache in response to the activation of the host map cache management function, and deactivates the host map cache management function when the number of transmissions exceeds a threshold value during the host map cache management operation.

6. The memory system of claim 1, wherein the controller deactivates the host map cache management function when a predetermined period of time elapses after the host map cache management function is activated.

7. The memory system of claim 1, wherein the controller deactivates the host map cache management function when the memory system is booted up.

8. The memory system of claim 1, wherein the controller includes a map cache configured to store the map data, and activates the host map cache management function when there occurs replacement of map data stored in the map cache.

9. The memory system of claim 1, wherein the controller performs the host map cache management operation in response to a read request received from the host device.

10. The memory system of claim 9, wherein the controller performs the host map cache management operation by providing the host device with a map data hint indicating map data satisfying a host map cache condition, receiving a map data request from the host device, and providing the host device with map data corresponding to a map data request received from the host device.

11. The memory system of claim 10, wherein the controller determines whether to deactivate the host map cache management function after performing the host map cache management operation.

12. A memory system comprising:
a storage medium configured to store map data; and
a controller configured to manage a number of transmissions of the map data to a host device in response to the activation of a host map cache management function, and deactivate the host map cache management function based on the number of transmissions.

13. The memory system of claim 12, wherein the controller includes a map cache configured to store the map data, and deactivates the host map cache management function when an empty space is generated within the map cache.

14. A memory system comprising:
a storage medium configured to store map data; and
a controller including a map cache configured to store the map data, the controller activating or deactivating a host map cache management function for a host map cache that is capable of storing the map data separately from the map cache,
wherein the controller determines whether there occurs an activation condition of the host map cache management function when there occurs a map cache miss within the map cache in response to a read request provided by a host device.

15. The memory system of claim 14, wherein the activation condition includes whether there occurs replacement of map data stored in the map cache.

16. The memory system of claim 14, wherein, when there is occurs a host map cache miss within the host map cache in response to the read request and the host map cache management function is activated, the controller performs a host map cache management operation and then determines whether there occurs a deactivation condition of the host map cache management function.

17. The memory system of claim 16, wherein the deactivation condition occurs when an empty space is generated within the map cache.

18. The memory system of claim 16, wherein the deactivation condition occurs when a number of transmissions of map data to the host map cache exceeds a threshold value.

19. The memory system of claim 16, wherein the deactivation condition occurs when a predetermined period of time elapses after the host map cache management function is activated.

20. The memory system of claim 16, wherein the controller performs the host map cache management operation by providing the host device with a map data hint indicating map data satisfying a host map cache condition, receiving a map data request from the host device, and providing the host device with the map data satisfying the host map cache condition.
